(19) United States
(12) Patent Application Publication
(10) Pub. No.: US 2020/0067436 A1
(43) Pub. Date: Feb. 27, 2020

(54) DYNAMIC GENERATOR SYSTEM

(71) Applicant: Briggs & Stratton Corporation, Wauwatosa, WI (US)

(72) Inventor: Brian Northway, Hartford, WI (US)

(73) Assignee: Briggs & Stratton Corporation, Wauwatosa, WI (US)

(21) Appl. No.: 16/548,625

(22) Filed: Aug. 22, 2019

Related U.S. Application Data
(60) Provisional application No. 62/723,422, filed on Aug. 27, 2018.

(51) Int. Cl. H02P 9/00; F02B 63/04

(52) U.S. Cl. CPC H02P 9/008; H02J 7/1438; F02B 63/04

(57) ABSTRACT

A generator management system is provided. The generator management system includes a generator and including an engine, a controller communicably coupled and operatively coupled to the generator to control operation of the generator. The controller includes a load sensing circuit structured to receive a load value of the engine, a fuel level sensing circuit structured to receive a fuel level value of a fuel source supplying fuel to the engine, and an evaluation circuit. The evaluation circuit structured to receive the load value of the engine from the load sensing circuit, receive the fuel level value from the fuel level sensing circuit, evaluate the load value and the fuel value to determine a remaining runtime of the generator, and control the generator to selectively supply power to a subset of one or more load sources based on the remaining runtime of the generator and a desired runtime of the generator.

### CROSS-REFERENCE TO RELATED APPLICATIONS

The present application claims the benefit of and priority to U.S. Provisional Patent Application No. 62/723,422, filed Aug. 27, 2018, which is incorporated by reference herein in its entirety.

### BACKGROUND

The present invention generally relates to internal combustion engines and generators powered by such engines. More specifically, the present invention relates to a control system for a generator.

### SUMMARY OF THE INVENTION

One implementation of the present disclosure is a generator management system for use with a generator. The generator management system includes a generator, the generator selectively supplying power to one or more load sources. The generator includes an engine. The generator management further includes a controller communicably and operatively coupled to the generator to control operation of the generator. The controller includes a load sensing circuit structured to receive a load value of the engine, a fuel level sensing circuit structured to receive a fuel level value of a fuel source supplying fuel to the engine, and an evaluation circuit. The evaluation circuit structured to receive the load value of the engine from the load sensing circuit, receive the fuel level value from the fuel level sensing circuit, evaluate the load value and the fuel value to determine a remaining runtime of the generator, and control the generator to selectively supply power to a subset of one or more load sources based on the remaining runtime of the generator and a desired runtime of the generator.

Another implementation of the present disclosure is a generator for supplying power to one or more load sources. The generator includes an engine, a throttle movable to a plurality of positions between closed and wide-open, a governor coupled to the throttle to open and close the throttle, a load sensor structured to sense a position of the throttle, a fuel level sensor structured to sense a fuel level in a fuel tank supplying fuel to the engine, and a controller structured to control operation of the generator. The controller includes a load sensing circuit structured to receive a load value of the engine from the load sensor, a fuel level sensing circuit structured to receive a fuel level value of a fuel tank providing fuel to the engine from the fuel level sensor, and an evaluation circuit. The evaluation circuit structured to receive the load value of the engine from the load sensing circuit, receive the fuel level value from the fuel level sensing circuit, evaluate the load value and the fuel value to determine a remaining runtime of the generator, and control the generator to selectively supply power to a subset of one or more load sources based on the remaining runtime of the generator and a desired runtime of the generator.

Another implementation of the present disclosure is a method for controlling a generator. The method includes receiving, by a load sensing circuit, a load value of the generator; receiving, by a fuel sensing circuit, a fuel level of a fuel source supplying fuel to the generator; evaluating, by an evaluation circuit, the load value and the fuel level; determining, from the evaluation, remaining runtime of the generator; and receiving, by a user device, user input, wherein the user input includes a prioritization of one or more load sources. The prioritization includes a first priority load source and a second priority load source. The priority of supply of power to the first priority load source is higher than supply of power to the second priority load source. The method further includes controlling, by a controller communicably and operatively coupled to the generator, the generator to selectively supply power to a subset of the one or more load sources based on the remaining runtime of the generator, the desired runtime of the generator, and the prioritization of the one or more load sources.

### BRIEF DESCRIPTION OF THE DRAWINGS

The disclosure will become more fully understood from the following detailed description, taken in conjunction with the accompanying figures, in which:

FIG. 1A is a schematic diagram of a generator according to an exemplary embodiment of the invention;

FIG. 1B is a schematic diagram of a generator according to an exemplary embodiment of the invention;

FIG. 2 is a schematic diagram of a generator management system for use with the generator of FIGS. 1A-1B, according to an exemplary embodiment of the invention;

FIG. 3 is a schematic diagram of the fuel management system of FIG. 2, according to an exemplary embodiment of the invention;

FIG. 4 is an example user interface of a user device for use with the generator management system of FIG. 2;

FIG. 5 is another example user interface of a user device for use with the generator management system of FIG. 2;

FIG. 6 is another example user interface of a user device for use with the generator management system of FIG. 2; and

FIG. 7 is another example user interface of a user device for use with the generator management system of FIG. 2.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, a generator management system is shown. The generator management system is configured to use fuel and load sensors to determine a remaining runtime of a generator (e.g., standby generator powering a residence). The generator may be powering various load sources, including appliances, such as a refrigerator or oven, an air conditioner system, a furnace, lighting, etc. The generator management system controls the generator to selectively power each of the load sources electrically connected to the generator. By determining the remaining runtime of the generator, the system can selectively provide power to a subset of the load sources (e.g., that may be prioritized by the system or through user input) to extend the remaining runtime. For example, a user may indicate (e.g., through an application on their mobile device) that power to an oven and dryer is not necessary during a power outage. As such, the generator management system will not provide power to those load sources and instead, will prioritize other load sources electrically connected to the generator. Accordingly, the system described herein extends the runtime of generators when fuel sources may be limited by reducing the load on the generator through prioritization and selection of load sources.

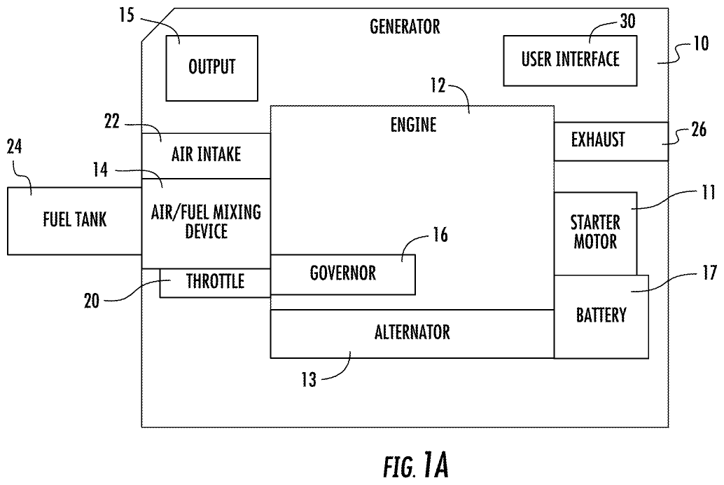

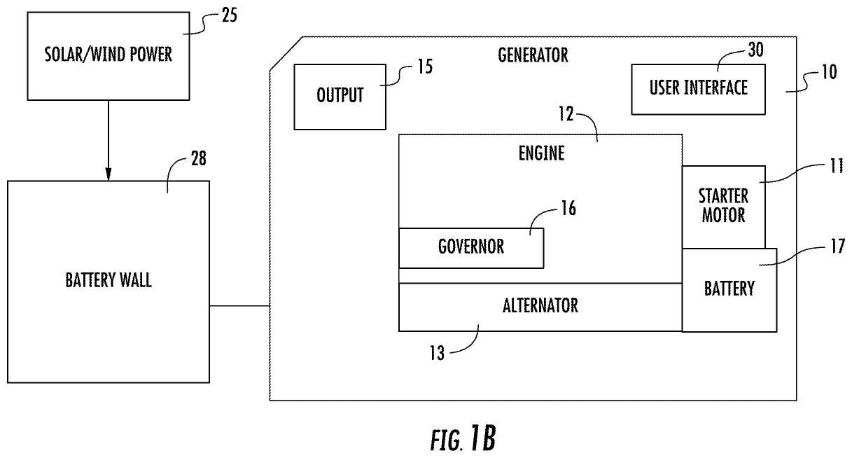

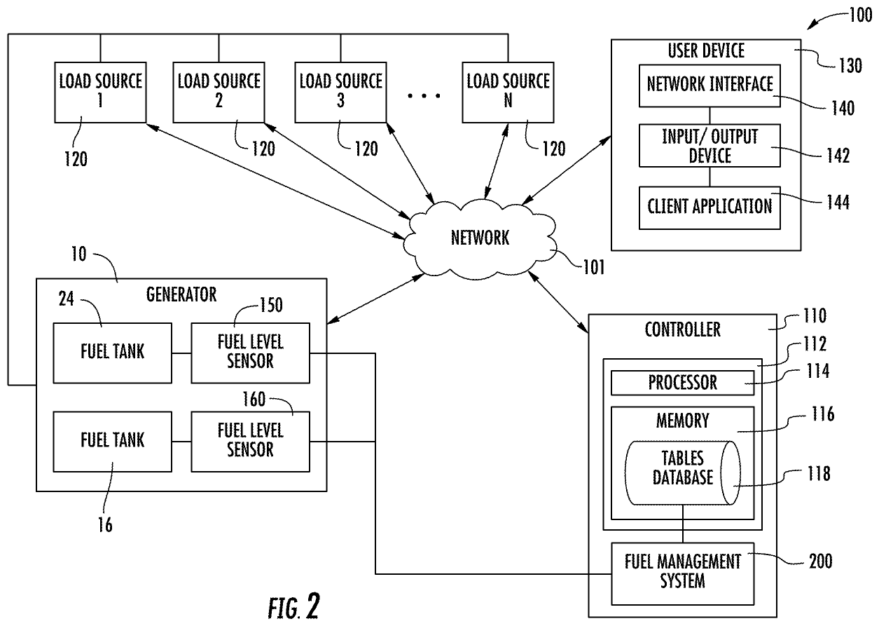

Referring to FIGS. 1A-1B, a generator is shown according to an exemplary embodiment. The generator 10 includes an engine 12, including a starter motor 11, air/fuel mixing device 14, governor 16, throttle 20, air intake 22, exhaust outlet 26, and an alternator 13 driven by the engine 12. The starter motor 11 rotates a crankshaft to start the engine 12. The alternator 13 produces electrical power from input mechanical power from the engine 12. The alternator 13 charges a battery 17, which stores energy for use by the electrical systems of the generator. The generator 10 additionally includes one or more outputs 15 for supply of the generated electrical power to an electrical device of a user's choosing. The generator 10 shown in FIG. 1A also includes a fuel tank 24 for providing fuel to the air/fuel mixing device 14. The fuel tank 24 can include a diesel fuel tank or a liquefied petroleum gas (LPG) tank (e.g., propane tank) used to supply fuel to the generator 10. As shown in FIG. 2, a fuel level sensor 150 is coupled to (e.g., within) the fuel tank 24 to sense an amount of fuel within the fuel tank 24.

Referring to FIG. 1B, the generator 10 is shown in use with a battery wall 28, according to an exemplary embodiment. The battery wall 28 is used to supplement or replace a diesel or LPG fuel source option. As shown in FIG. 1B, solar power and/or wind power source 25 is used to charge the battery wall 28. During power outages, the solar power and/or wind power source 25 supplies power to the battery wall 28, which stores the energy for use to power the generator 10 during power outages. An inverter is included to convert the direct current (DC) power into alternating current (AC) power used by the generator 10. The battery wall 28 is communicably and operatively coupled to the fuel management system 200 to communicate the amount of battery power left for use to power the generator 10. In some embodiments, the battery power from the battery wall 28 and the fuel from the fuel tank 24 (shown in FIG. 1A) may be used to supplement one another. For example, the generator 10 receives propane as a primary fuel source and battery power as a secondary fuel source.

Air flows into the engine 12 from the air intake 22 and through the air/fuel mixing device 14. As air passes through the air/fuel mixing device 14, the air mixes with fuel entering the air/fuel mixing device 14 from the fuel tank 24 and creates an air/fuel mixture that then enters the engine 12. The throttle 20 controls the flow of the air/fuel mixture that exits the air/fuel mixing device 14. The governor 16 controls the position of the throttle 20 based on a detected load on the engine 12. In one embodiment, the governor 16 is an electronic governor. In another embodiment, the governor 16 is a mechanical governor. The air/fuel mixture leaving the air/fuel mixing device 14 is combusted in one or more cylinders of the engine 12 and exhaust gas from combustion leaves the engine 12 through the exhaust outlet 26. In one embodiment, the air/fuel mixing device 14 includes an electronic fuel injection (EFI) system. In another embodiment, the air/fuel mixing device 14 includes a carburetor.

The throttle 20 is structured to control the flow of air/fuel mixture out of the air/fuel mixing device 14. The position of the throttle 20 is controlled by the governor 16 through a linkage which moves the throttle plate. Based on the load sensed by the governor 16, the throttle plate may be in a relatively more closed or relatively more open position. As shown in FIG. 2, a load sensor 160 is coupled to the governor 16 to sense a load on the engine 12.

Referring to FIG. 2, a generator management system 100 for a generator 10 is illustrated, according to an exemplary embodiment. The generator management system 100 includes a fuel management system 200, the generator 10, and one or more load sources 120 powered by the generator 10. The load sources 120 include any source of load on the generator 10 and can include, but are not limited to, a lighting system inside or outside a residence, a refrigerator, an oven, a dryer, an air conditioning unit, a furnace, etc. The generator 10 and the load sources 120 are communicably and operatively coupled to the fuel management system 200. As shown in FIG. 2, the generator management system 100 includes a controller 110, which includes and operates the fuel management system 200.

In some embodiments, the generator management system 100 also includes a user device 130 communicably and operatively coupled to the generator 10, controller 110 (e.g., fuel management system 200), and one or more load sources 120 over a network 101, which may include one or more of the Internet, cellular network, Wi-Fi, or any other type of wired or wireless network. In some embodiments, the generator management system 100 includes more or less sensors than are shown in FIG. 2.

The generator 10 includes a fuel level sensor 150 coupled to the fuel tank 24 and a load sensor 160 coupled to the governor 16. The fuel level sensor 150 is configured to sense a fuel level within the fuel tank 24. In some embodiments, more than one fuel tank 24 may be used and as such, the fuel level sensor 150 can sense the fuel level in each tank (e.g., diesel tank, LPG tank). In one embodiment, a fuel level sensor 150 can be positioned within each fuel tank 24 such that the fuel level of each tank is determined. In another embodiment, a weight sensor can be positioned within each LPG tank such that the fuel levels of each LPG fuel tank can be determined. In addition, the battery wall 28 shown in FIG. 1B is communicably and operatively coupled to the controller 110 and/or fuel management system 200 (e.g., fuel level sensing circuit 210) to communicate the amount of battery power left for use to power the generator 10.

The load sensor 160 is configured to sense a load on the engine. As such, in some embodiments, the load sensor 160 is communicably coupled to the governor 16 to determine a load on the engine 12. In some embodiments, the load sensor 160 is communicably coupled to a throttle position sensor to determine a load on the engine 12. In another embodiment, the load sensor 160 is coupled to a manifold absolute pressure (MAP) sensor to detect the load on the engine 12. The MAP sensor responds to an intake manifold pressure and provides a sensed load reading based on that pressure. In yet another embodiment, the load sensor 160 includes a sensor at one or more outlets 15 to determine an output current for the generator 10 from which a load can be determined.

The user device 130 includes any type of computing device that may be used to control the operation of the generator management system 100. In some embodiments, a user uses the user device 130 to communicate information to the controller 110 (e.g., fuel management system 200 operated by and included in controller 110) over the network 101. The user device 130 can also be used to control the operation of load sources 120 that are smart appliances (e.g., smart refrigerator, etc.) or smart lighting systems. The user device 130 can include any type of mobile device including, but not limited to, a phone (e.g., smart phone, etc.), tablet, personal digital assistant, and/or computing devices (e.g., desktop computer, laptop computer, personal digital assistant, etc.). The user device 130 can also include any wearable or non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. The user device 130 can also include any type of smart home device including a speaker and microphone to receive inputs from a user and notify the user of the status of the generator 10 and system 100.

The user device 130 includes a network interface 140 enabling the user device 130 to exchange information over the network 101, an input/output (“I/O”) device 142, and a client application 144. The I/O device 142 is configured to exchange information with the user. An input device or component of the I/O device 142 allows the user to provide information to the user device 130, and may include, for example, a mechanical keyboard, a touchscreen, a microphone, a camera, a fingerprint scanner, any user input device engageable with the user device 130 via a USB, serial cable, Ethernet cable, and so on. An output device or component of the I/O device 142 allows the user to receive information from the user device 130, and may include, for example, a digital display, a speaker, illuminating icons, LEDs, and so on.

The client application 144 is structured to provide displays to the user device 130 that enable the user to manage the generator management system 100. Accordingly, the client application 144 is communicably coupled to the generator 10 and controller 110 (e.g., fuel management system 200, etc.). In some embodiments, the client application 144 may be incorporated with an existing application in use by a provider of smart home systems or smart appliance systems. In other embodiments, the client application 144 is a separate software application implemented on the user device 130. The client application 144 may be downloaded by the user device 130 prior to its usage, hard coded into the memory of the user device 130, or be a web-based interface application such that the user device 130 may provide a web browser to the application, which may be executed remotely from the user device 130. In the latter instance, the user may have to log onto or access the web-based interface before usage of the applications. Further, and in this regard, the client application 144 may be supported by a separate computing system including one or more servers, processors, network interface circuits, etc. that transmit applications for use to the user device 130. In certain embodiments, the client application 144 includes an API and/or a software development kit (SDK) that facilitate the integration of other applications with the client application 144. For example, the client application 144 may include an API that facilitates the receipt of information from a dealer or provider of fuel or batteries.

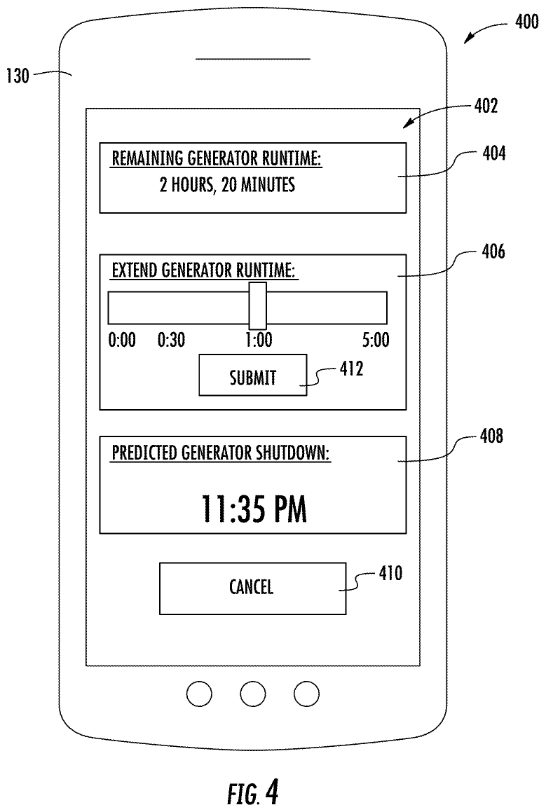

The displays presented to the user via the client application 144 may be indicative of current generator runtime, expected remaining generator runtime, status of load sources 120, current priority of load sources 120, and the like. Various user interfaces are shown in FIGS. 4-7.

The generator management system 100 includes a controller 110. The controller 110 is configured to control operation of the generator 10 and to which load sources 120 the generator 10 is supplying power. As such, the controller 110 is communicably and operatively coupled to the generator 10 to control operation of the generator 10 and selectively couple and decouple (e.g., turn on and off) load sources 120 from the generator 10. As shown, the controller 110 includes a processing circuit 112, which may include a processor 114 and a memory 116. The processor 114 may be implemented as a general-purpose processor, an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 116 (e.g., RAM, NVRAM, ROM, Flash Memory, hard disk storage) may store data and/or computer code for facilitating the various processes described herein. Moreover, the one or more memory devices 116 may be or include tangible, non-transient volatile memory or non-volatile memory. Accordingly, the one or more memory devices 116 may include database components, object code components, script components, or any other type of information structure for supporting the various activities and information structures described herein.

The controller 110 further includes a tables database 118. The tables database 118 holds, stores, categorizes, and otherwise serves as a repository for load versus runtime look-up tables corresponding to a remaining runtime of the generator 10 based on a current sensed load and remaining fuel level. The tables database 118 stores values including, but not limited to, load, fuel level, and user inputs, that may be used to determine a remaining runtime of the generator 10.

The tables database 118 is structured to provide access to information relating to the sensed values of the engine 12 and generator 10. In this regard, the tables database 118 is communicably and operatively coupled to the fuel management system 200 to provide access to such information, such that the fuel management system 200 may perform a certain operation (e.g., turn on/off load sources 120) based on those values.

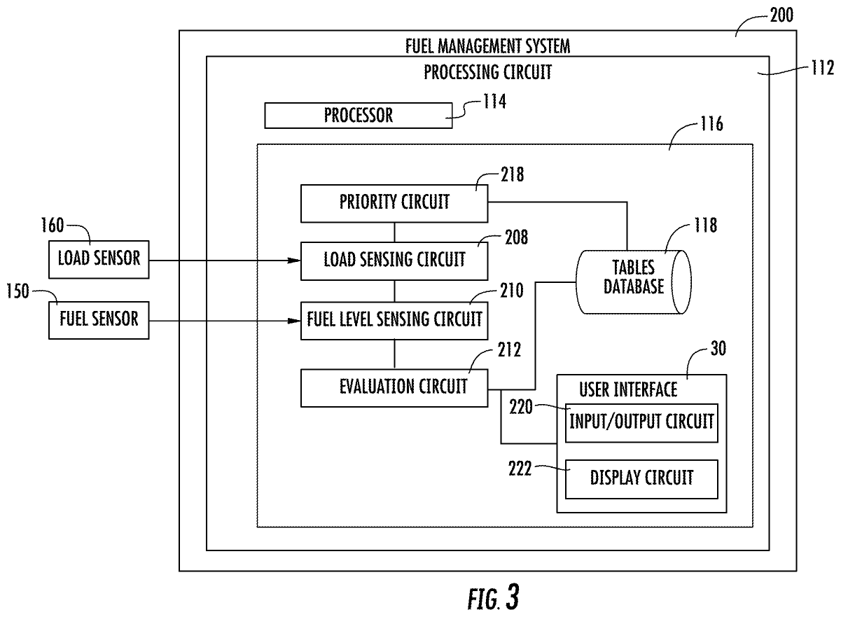

Referring now to FIG. 3, a diagram of a fuel management system 200 and part of the controller 110 of FIG. 2 are shown according to an exemplary embodiment. As mentioned above, the fuel management system 200 may be embodied with the controller 110. Accordingly, the fuel management system 200 may be embodied or at least partly embodied in the memory 116, where at least some operations may be executable from the processing circuit 112. The fuel management system 200 is shown to include a load sensing circuit 208, fuel level sensing circuit 210, evaluation circuit 212, priority circuit 218, and timing circuit 220, with all such circuits communicably coupled with each other. Other embodiments may include more or less circuits without departing from the spirit and scope of the present disclosure.

Each of the sensing circuits shown in FIG. 3 are structured to receive values from the corresponding sensors. The load sensing circuit 208 is structured to receive a sensed load value of the engine from the load sensor 160. The fuel level sensing circuit 210 is structured to receive a fuel level value from the fuel sensor 150 and/or the battery wall 28 shown in FIG. 1B. These values may be used in the evaluation circuit 212 to determine a remaining runtime of the generator 10, as described further herein. Accordingly, the load sensing circuit 208 and fuel level sensing circuit 210 are communicably coupled to the evaluation circuit 212 to communicate the current load and fuel level values to the evaluation circuit 212.

The load sensing circuit 208 is configured to sense a load on the engine 12 via the load sensor 160. In one embodiment, the load sensing circuit 208 receives position values from a throttle of the engine 12 to determine the load value. As such, in some embodiments, the load sensor 160 is communicably coupled to the governor 16 to determine a load on the engine 12. In another embodiment, output voltage values from the output 15 of the generator 10 are communicated to the load sensing circuit 208 to determine load.

The fuel level sensing circuit 210 receives sensing information from a fuel level sensor 150 within each fuel tank to determine fuel levels within each tank. For example, a weight sensor can be positioned within each LPG tank used such that the fuel levels of the tanks can be determined. As another example, a fuel level sensor 150 can be positioned within a diesel tank such that the fuel level of the diesel tank can be determined. The fuel level within the tanks can be used to determine the amount of runtime left for the generator 10. The fuel level sensing circuit 210 also receives battery power information from the battery wall 28 indicative of the remaining power left in the battery wall 28.

The priority circuit 218 is structured to determine a priority of load sources 120 that, when selectively powered, maximizes the runtime for the generator 10. The priority circuit 218 communicates the priority determination to the evaluation circuit 212. As such, the priority circuit 218 is communicably and operatively coupled to the evaluation circuit 212 to communicate the priority determination. The priority determination may or may not take into account received user prioritization input. For example, a user may indicate that a certain load source (e.g., a dryer, etc.) does not need to be powered during outages. In this case, the priority circuit 218 will not prioritize that load source 120. In some embodiments, the priority circuit 218 is also configured to receive a priority indication from the user device 130. The user can prioritize all or some of the load sources 120 using the client application 144 on the user device 130. The prioritized list is transmitted from the user device 130 to the priority circuit 218.

The evaluation circuit 212 is structured to communicate with each of the load and fuel level sensing circuits 208, 210, and additionally communicate with the tables database 118 to determine the amount of runtime left for the generator 10 based on the current load and fuel level. For each sensed load on the engine 12, the runtime varies, as more or less fuel is consumed based on the load on the engine 12. With the same amount of fuel left in the fuel tank 24, the remaining generator runtime is longer for lower loads on the engine 12 than for higher loads on the engine 12 due to more fuel being consumed under higher loads. In another embodiment, the evaluation circuit 212 does not include a tables database and instead, calculates the amount of runtime left for the generator 10 based on the current sensed load received from the load sensing circuit 208 and the fuel level value received from the fuel level sensing circuit 210 without referencing a tables database.

The evaluation circuit 212 communicates the determined runtime data to the user interface 30 of the generator 10 and/or the user device 130. Accordingly, the evaluation circuit 212 is communicably and operatively coupled to the user interface 30 and user device 130. The evaluation circuit 212 is coupled to the user device 130 via the network 101. The evaluation circuit 212 communicates the runtime data as a generated message to be displayed in the form of text, picture, schematic representation, etc. In some embodiments, the evaluation circuit 212 can also determine the runtime in various operating scenarios and generate a message displaying various scenarios to the user. The scenarios can include an expected generator runtime based on if certain load sources 120 are switched off and suggestions to switch off particular load sources 120 to achieve a certain generator runtime goal.

The evaluation circuit 212 is also configured to receive a user input provided by a user interface 30 of the generator 10 or a user device 130 connected via a network 101 as shown in FIG. 2. User input may include, but is not limited to, an expected utility downtime, an amount of time to extend the generator runtime (e.g., extending runtime by hours and minutes), a preset generator shutdown time indicating to what time the user would like the generator runtime extended (e.g., extending the generator runtime to 10:30 pm), prioritizing and selecting operating conditions of load sources 120 (e.g., turning on/off refrigerator, lights). Various example user interfaces of the user device 130 are described in FIGS. 4-7.

In addition, the evaluation circuit 212 is configured to receive priority selection data as a user input from the user interface 30 or user device 130 and use the priority data to turn load sources 120 on and off based on that priority preference. Additionally, the evaluation circuit 212 communicates with the priority circuit 218 to determine a priority of load sources 120 that maximizes the runtime for the generator 10. As such, the evaluation circuit 212 is communicably and operatively coupled to the priority circuit 218 to receive such a priority determination. The priority determination may or may not take into account received user prioritization input.

In one example, the evaluation circuit 212 receives sensed load and fuel level values from the load and fuel sensing circuits 208, 210 and determines (e.g., through calculation, referencing tables database, etc.) that with the current load and fuel level, the generator 10 will run for approximately 5 hours. The evaluation circuit 212 generates and displays a message to the user indicating the runtime of 5 hours. The evaluation circuit 212 also generates a message stating that if electricity to the dryer and to the air conditioner is turned off, the expected runtime of the generator 10 would be extended to 10 hours instead of 5 hours. In various embodiments, the evaluation circuit 212 can generate and display various other messages for the user to view.

Still referring to FIG. 3, the user interface 30 included with the generator 10 includes an input/output circuit 220 and a display circuit 222. The input/output circuit 220 is structured to receive and provide communication(s) to a user (e.g., a dealer, a consumer) of the generator 10. In this regard, the input/output circuit 220 is structured to exchange data, communications, instructions, etc. with an input/output component of the generator 10. Accordingly, in one embodiment, the input/output circuit 220 includes an input/output device such as a display device, a touchscreen, a keyboard, and a microphone. In another embodiment, the input/output circuit 220 may include communication circuitry for facilitating the exchange of data, values, messages, and the like between an input/output device and the components of the generator 10. In yet another embodiment, the input/output circuit 220 may include machine-readable media for facilitating the exchange of information between the input/output device and the components of the generator 10. In still another embodiment, the input/output circuit 220 may include any combination of hardware components (e.g., a touchscreen), communication circuitry, and machine-readable media.

The display circuit 222 is used to present runtime information, fuel level information, and the like to users on the user interface 30. In this regard, the display circuit 222 is communicably and operatively coupled to the input/output circuit 220 to provide a user interface for receiving and displaying information on the generator 10.

Referring now to FIG. 4, an example user interface 400 of the user device 130 is shown. The user interface 400 includes an interactive area 402, where the user can input values and preferences. The interactive area 402 includes a “Remaining Generator Runtime” display 404 that includes the expected remaining generator runtime for the current load and fuel level. The interactive area 402 also includes an “Extend Generator Runtime” display 406 that allows a user to input an extended amount of time for the generator 10 to run. In the example shown, the user has input that the generator 10 runtime should be extended by one hour. The interactive area 402 also includes a “Predicted Generator Shutdown” text box 408 that displays the current predicted generator shutdown time. In addition, instead of extending the generator runtime using the “Extend Generator Runtime” display 406, the user can input a specific generator shutdown time into the “Predicted Generator Shutdown” text box 408. The user interface 400 also includes a “Submit” selection 412 that the user can select to input the time values entered and a “Cancel” selection 410 the user can select to exit the user interface 400.

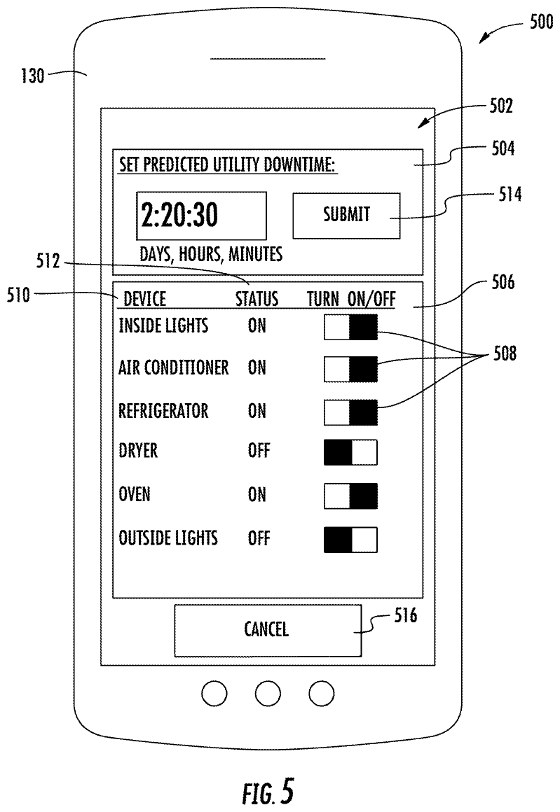

Referring to FIG. 5, another example user interface 500 is shown. The user interface 500 includes an interactive area 502, where a user can input values and preferences. The interactive area 502 includes a “Set Predicted Utility Downtime” display 504, where a user can input how long the user expects a power outage to last. In some cases, the user may be in contact with a utility company and receives information indicative of a predicted outage period. The user can input this expected downtime information and the generator management system 100 increases or decreases the amount of load on the generator 10 to allow the generator 10 to run for that period of time. The interactive area 502 also includes a prioritization box 506 including a device listing 510, a status listing 512 for each device, and a turn on/off selections 508. The user can toggle the selections 508 between on and off to indicate whether each load source should be on and receiving power from the generator 10. As shown in the example user interface 500, the user has indicated that the user does not require use of a dryer or outside lights during a power outage and as such, has turned those load sources off. The user interface 500 also include a “Submit” selection 514 that the user can select to input the time and selection values and a “Cancel” selection 516 the user can select to exit the user interface 500.

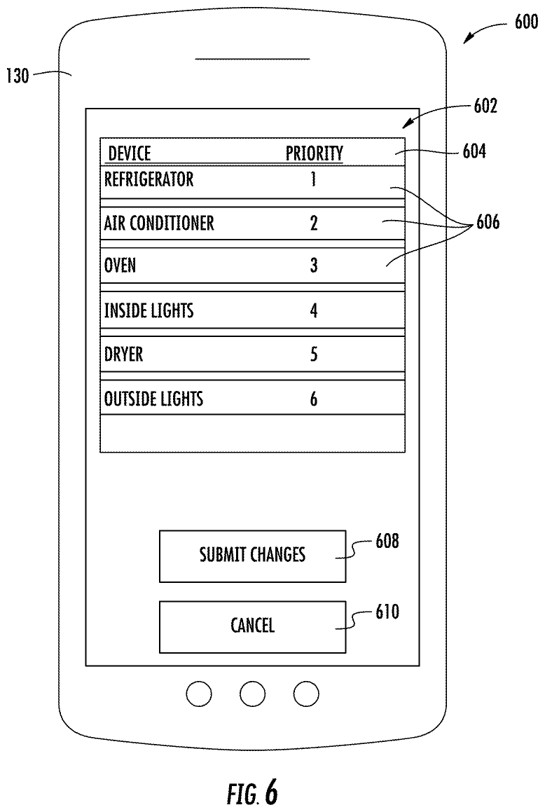

Referring to FIG. 6, another example user interface 600 is shown. The user interface 600 includes an interactive area 602, where a user can input values and preferences. The interactive area 602 includes a priority list display 604, where a user can select the priority of various load sources 120. The user can move each load source row 606 up or down depending on its priority. If the user moves the load source row 606 up, the priority goes up, and if the user moves the load source row 606 down, the priority for that particular load source 120 goes down. Higher priority load sources will be powered before lower priority load sources. As shown in the example user interface 600, powering the refrigerator will be prioritized over the other load sources 120. The user interface 600 also include a “Submit Changes” selection 608 that the user can select to input the priority values and a “Cancel” selection 610 the user can select to exit the user interface 600.

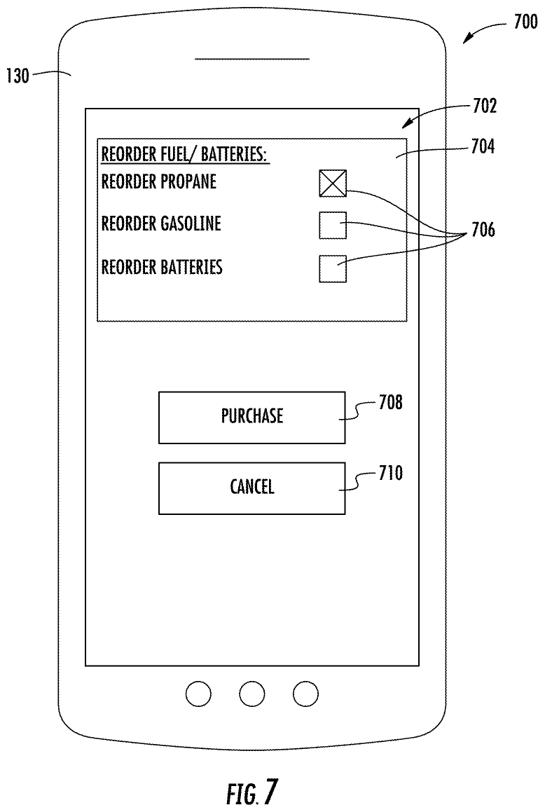

Referring to FIG. 7, another example user interface 700 is shown. The user interface 700 includes an interactive area 702, where a user can input values and preferences. The interactive area 702 includes an order list display 704, where a user can order fuel sources for delivery to the user using order selections 706. As shown in the example user interface 700, the user has selected the order selection 706 for reordering propane. The user interface 700 also include a “Purchase” selection 708 that the user can select to purchase the fuel selected and a “Cancel” selection 710 the user can select to exit the user interface 700. User interface 700 may be generated through connection with a dealer or another third party website.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

What is claimed is:

1. A generator management system for use with a generator, the system comprising:
a generator selectively supplying power to one or more load sources, the generator including an engine; and
a controller communicably and operatively coupled to the generator to control operation of the generator, the controller comprising:
a load sensing circuit structured to receive a load value of the engine;
a fuel level sensing circuit structured to receive a fuel level value of a fuel source supplying fuel to the engine; and
an evaluation circuit structured to:
receive the load value of the engine from the load sensing circuit;
receive the fuel level value from the fuel level sensing circuit;
evaluate the load value and the fuel level value to determine a remaining runtime of the generator; and
control the generator to selectively supply power to a subset of the one or more load sources based on the remaining runtime of the generator and a desired runtime of the generator.

2. The system of claim 1, wherein the evaluation circuit is further structured to evaluate an updated load value and an updated fuel level value based on the generator supplying power to the subset of the one or more load sources and determine an updated remaining runtime of the generator.

3. The system of claim 1, wherein the evaluation circuit is further structured to generate and transmit a message for display to a user interface of the generator indicating the remaining runtime of the generator.

4. The system of claim 1, wherein the evaluation circuit is further structured to generate and transmit a message for display to a user device connected via a network indicating the remaining runtime of the generator.

5. The system of claim 1, wherein the controller further comprises a priority circuit structured to prioritize supplying power to a prioritized subset of the one or more load sources to maximize the remaining runtime of the generator;
wherein the evaluation circuit communicates with the priority circuit to receive the prioritized subset of the one or more load sources and controls the generator to selectively supply power to only the prioritized subset of the one or more load sources.

6. The system of claim 1, further comprising a user device structured to receive user input and transmit the user input to the controller;
wherein the user input includes a prioritization of the one or more load sources, the prioritization including a first priority load source and a second priority load source, wherein priority of supply of power to the first priority load source is higher than supply of power to the second priority load source;
wherein the evaluation circuit is structured to receive the user input and control the generator to selectively supply power to the first priority load source prior to supplying power to the second priority load source.

7. The system of claim 6, wherein the user device comprises at least one of a mobile device, a smart home device, and a smart appliance.

8. The system of claim 1, further comprising a user device structured to receive user input and transmit the user input to the controller;
wherein the user input includes a selection of the subset of one or more load sources to which to supply power;
wherein the evaluation circuit is structured to receive the user input and control the generator to selectively supply power to only the subset of one or more load sources.

9. The system of claim 8, wherein the user device comprises at least one of a mobile device, a smart home device, and a smart appliance.

10. The system of claim 1, further comprising a tables database, wherein the evaluation circuit evaluates the load value and the fuel level value to determine a remaining runtime of the generator from the tables database.

11. The system of claim 1, wherein the fuel source includes at least one of a diesel fuel tank, a liquefied petroleum gas tank, and one or more batteries.

12. A generator for supplying power to one or more load sources, the generator comprising:
an engine;
a throttle movable to a plurality of positions between closed and wide-open;
a governor coupled to the throttle to open and close the throttle;
a load sensor structured to sense a position of the throttle;
a fuel level sensor structured to sense a fuel level in a fuel tank supplying fuel to the engine; and
a controller structured to control operation of the generator, the controller comprising:
a load sensing circuit structured to receive a load value of the engine from the load sensor;
a fuel level sensing circuit structured to receive a fuel level value of a fuel tank providing fuel to the engine from the fuel level sensor; and
an evaluation circuit structured to:
receive the load value of the engine from the load sensing circuit;
receive the fuel level value from the fuel level sensing circuit;
evaluate the load value and the fuel level value to determine a remaining runtime of the generator; and
control the generator to selectively supply power to a subset of one or more load sources based on the remaining runtime of the generator and a desired runtime of the generator.

13. The generator of claim 12, wherein the evaluation circuit is further structured to evaluate an updated load value and an updated fuel level value based on the generator supplying power to the subset of the one or more load sources and determine an updated remaining runtime of the generator.

14. The generator of claim 12, wherein the evaluation circuit is further structured to generate and transmit a message for display to a user interface of the generator indicating the remaining runtime of the generator.

15. The generator of claim 12, wherein the controller further comprises a priority circuit structured to prioritize supplying power to a prioritized subset of the one or more load sources to maximize the remaining runtime of the generator;
wherein the evaluation circuit communicates with the priority circuit to receive the prioritized subset of the one or more load sources and controls the generator to selectively supply power to only the prioritized subset of the one or more load sources.

16. The generator of claim 12, wherein the evaluation circuit is further structured to receive user input including a prioritization of the one or more load sources, the prioritization including a first priority load source and a second priority load source, wherein priority of supply of power to the first priority load source is higher than supply of power to the second priority load source;
wherein the evaluation circuit is structured to receive the user input and control the generator to selectively supply power to the first priority load source prior to supplying power to the second priority load source.

17. The generator of claim 12, wherein the evaluation circuit is further structured to receive user input including a selection of the subset of one or more load sources to which to supply power;
wherein the evaluation circuit is structured to receive the user input and control the generator to selectively supply power to only the subset of one or more load sources.

18. The generator of claim 12, further comprising a tables database, wherein the evaluation circuit evaluates the load value and the fuel level value to determine a remaining runtime of the generator from the tables database.

19. A method for controlling a generator, the method comprising:
receiving, by a load sensing circuit, a load value of the generator;
receiving, by a fuel sensing circuit, a fuel level of a fuel source supplying fuel to the generator;
evaluating, by an evaluation circuit, the load value and the fuel level;
determining, from the evaluation, remaining runtime of the generator
receiving, by a user device, user input, wherein the user input includes a prioritization of one or more load sources, the prioritization including a first priority load source and a second priority load source, wherein priority of supply of power to the first priority load source is higher than supply of power to the second priority load source;
controlling, by a controller communicably and operatively coupled to the generator, the generator to selectively supply power to a subset of the one or more load sources based on the remaining runtime of the generator, the desired runtime of the generator, and the prioritization of the one or more load sources.

20. The method of claim 19, further comprising:
evaluating an updated load value and an updated fuel level value based on the generator supplying power to the subset of the one or more load sources;
determining an updated remaining runtime of the generator based on the updated load value and the updated fuel level value.
